(19) United States
(12) Patent Application Publication
(10) Pub. No.: US 2013/0024383 A1
(43) Pub. Date: Jan. 24, 2013

(54) Mobile Device With Secure Element

(71) Applicant: Sasikumar Kannappan, Foster City, CA (US)

(72) Inventor: Sasikumar Kannappan, Foster City, CA (US)

(21) Appl. No.: 13/552,559

(22) Filed: Jul. 18, 2012

Related U.S. Application Data
(60) Provisional application No. 61/509,043, filed on Jul. 18, 2011.

(51) Int. Cl. G06Q 20/40; H04L 9/00; G06Q 20/32

(52) U.S. Cl. 705/71

(57) ABSTRACT

Embodiments of the present invention are directed to methods, systems, and apparatuses for securely communicating issuer updates, upgrades, and allowing configuration of payment-related applications on a mobile communication device using a mobile security application. One embodiment is directed to a method of using a mobile communication device comprising a mobile security application, a key associated with the mobile security application, a first mobile payment application in communication with the mobile security application and a second mobile payment application in communication with the mobile security application. The method includes communicating, by the first mobile payment application in the mobile communication device with a mobile gateway, in a first communication, wherein the first communication is encrypted using the key and communicating, by the second mobile payment application in the mobile communication device with a mobile gateway, in a second communication, wherein the second communication is encrypted using the key.

### CROSS-REFERENCES TO RELATED APPLICATIONS

This application claims the benefit of U.S. Provisional Application No. 61/509,043, filed Jul. 18, 2011, titled “MOBILE DEVICE WITH SECURE ELEMENT,” which is incorporated by reference in its entirety for all purposes.

### BACKGROUND

The uses and capabilities of mobile communication devices have rapidly increased in recent years. For example, mobile communication device users now have the capability to make payments using their mobile phone. While mobile payments provide a convenient tool for a consumer, mobile payments may also present security concerns. Sensitive information, such as a consumer's personal information, account information, etc., can be prone to interception. Additionally, if the mobile communication device is lost or stolen, such information can be used by an unauthorized user. Furthermore, as mobile payment applications evolve, there is a need not only to protect information sent from the mobile communication device, but also to protect information sent to the mobile communication device during transmission.

For example, when payments are made using a physical card with an embedded chip, the issuer associated with the payment card can update data in the chip during the course of a payment transaction. Chip data may be returned in the payment transaction response that contains authentication data or scripts for updating risk parameters and payment counters in the chip payment application. These issuer updates typically required the card to be inserted into a contact point-of-sale terminal. However, when a mobile communication device is used as a payment device, the mobile communication device cannot be inserted into a point-of-sale terminal to conduct a contact point-of-sale transaction and to receive issuer updates. Accordingly, for mobile payments, issuer updates may be provided by a third party in communication with a mobile payment application on a mobile communication device. However, the use of a third party increases the number of discrete systems that are required to make an update, with a subsequent increase in the likelihood of an error, higher use of communication, memory, archiving, and processing resources, higher consumption of power, etc. Also, transaction costs are high for contacting a third party whenever an update is necessary. As such, there is an additional need for an issuer update solution for mobile communication devices that are used as payment devices, where the issuer can preferably communicate directly with the mobile payment application.

Embodiments of the present technology address these and other problems.

### BRIEF SUMMARY

Aspects of the embodiments of the present technology relate in general to improved systems and methods for authentication of communications for management and configuration of payment-related applications on a mobile communication device. Such systems and methods improve the security of information transferred to and from a mobile communication device and a mobile gateway by providing efficient means for authentication.

One embodiment of the technology is directed at a method of using a mobile communication device comprising a mobile security application, a key associated with the mobile security application, a first mobile payment application in communication with the mobile security application and a second mobile payment application in communication with the mobile security application. The method includes communicating, by the first mobile payment application in the mobile communication device with a mobile gateway, in a first communication, wherein the first communication is encrypted using the key and communicating, by the second mobile payment application in the mobile communication device with a mobile gateway, in a second communication, wherein the second communication is encrypted using the key.

Another embodiment of the technology is directed at a mobile communication device comprising a processor, a secure element comprising a mobile security application associated with the processor, a key associated with a mobile security application, a first payment application associated with the mobile security application, and a second payment application associated with the mobile security application, wherein the processor is configured to use the key to encrypt a first communication between the first mobile payment application and a mobile gateway, and wherein the processor is further configured to use the key to encrypt a second communication between the second mobile payment application and the mobile gateway; and an antenna coupled to the processor.

These and other embodiments of the technology are described in further detail below.

### BRIEF DESCRIPTION OF THE DRAWINGS

FIG. 1 illustrates a transaction flow diagram within a mobile gateway context including both a transaction system and provisioning and communication system.

FIG. 2 illustrates a diagram of a mobile communication device comprising two mobile payment applications communicating with a mobile gateway using two separate encryption keys to create two separate secure channels.

FIG. 3 illustrates a diagram of a mobile communication device comprising a mobile security application and two mobile payment applications communicating with a mobile gateway using a single key associated with the mobile security application to create a single secure channel for communications between each separate mobile payment application and a mobile gateway.

FIG. 4 depicts an exemplary block diagram of a mobile communication device.

FIG. 5 depicts an exemplary flow diagram for a method of provisioning and configuring one of a plurality of mobile payment applications on a mobile communication device using a mobile security application.

FIG. 6 depicts an exemplary block diagram of a computer apparatus.

### DETAILED DESCRIPTION

Embodiments disclosed herein are directed to techniques for securely communicating with mobile payment applications on a mobile device, such as, e.g., a mobile communication device, using a mobile security application. Specifically, embodiments of the present invention are directed to a mobile security application located on a secure element of a mobile communication device that provides secure communications between the mobile communication device and issuers that configure, update, and maintain mobile payment applications on a secure memory of a mobile communication device. The mobile security application allows secure communications between multiple payment applications and multiple issuers using a single encryption key. The mobile security application creates a secure channel for communication with a mobile gateway which in turn creates a secure connection with a first entity (e.g., an issuer, payment processing network, etc.) to allow communication between the first entity and a first mobile payment application stored on the secure element. The secure channel can be used to securely send and receive payment-related application data. A second entity (e.g. a second issuer) may also use the secure channel to communicate with a second mobile payment application on the secure element through the mobile security application using the same key.

The mobile communication device can be provisioned with a mobile security application that may interact with a mobile gateway, and subsequently issuers of payment-related applications, for the transmission of data related to applications for performing financial transactions. The mobile security application may be provisioned on a secure element contained within the mobile communication device. The mobile security application may authenticate the mobile communication device to a mobile gateway using a key. Once authenticated, the mobile security application may allow communications related to a plurality of mobile payment applications issued from a plurality of different account issuers to configure, update, or control any of the mobile payment applications on the mobile communication device using the key associated with the mobile security application. Accordingly, the mobile security application may allow access to one or more mobile payment applications using a single key associated with the mobile security application. Each mobile payment application may be associated with a financial account of the consumer (e.g., credit card account, debit card account, etc.). Additionally, the mobile security application may communicate with an account not stored on the secure element and provide a secure communication channel for updating accounts that previously could not be secured (e.g. bank accounts).

Embodiments of the present invention provide a number of technical advantages including simplified key management for mobile payment applications issued by multiple entities, minimizing the utilization of technical resources including communication, processing, and memory resources, minimizing the transaction costs associated with contactless payment services by minimizing the number of provisioning transactions by trusted service managers, and providing secure access to accounts that typically have not been secured on mobile communications devices (e.g. bank accounts).

However, prior to discussing the example embodiments of the invention, a further description of some terms can be provided for a better understanding of the invention.

A “mobile security application” may be an application or applet providing security services for a mobile device. For example, the mobile security application may be installed in a secure element chip within a NFC-enabled portable communication device. The mobile security application provides the functionality to manage and maintain a plurality of mobile payment applications using a single encryption key (i.e. a mobile security application key). The mobile payment applications may in turn manage and maintain a consumer's payment information and support contactless payments. The mobile security application can be installed within a secure element to quickly, efficiently, and securely configure, manage, and maintain a plurality of mobile payment applications on the secure element. The mobile security application allows any number of entities issuing a mobile payment application to connect to their mobile payment application as installed on the mobile communication device using a single mobile security application key (i.e. key associated with the mobile security application).

An “application” may be computer code or other data stored on a computer readable medium (e.g. memory element or secure element) that may be executable by a processor to complete a task. An “applet” can be a simplified application that may be programmed to perform a single or limited specific number of tasks.

A “mobile security application key” or a “key associated with the mobile security application” is an encryption key that is suitable to be shared between entities to protect the security of the information in a communication. The key may be used by the mobile security application to create a secure connection between the mobile communication device and a mobile gateway. The mobile gateway may implement a key management center in order to manage the use of such keys. Additionally, the mobile security application key may be present in the mobile security application. The mobile gateway may provide a secure communication path between the mobile communication device and an issuer of a mobile payment application using the mobile security application key.

The mobile security application key may be a unique derived key (UDK) that is derived from a master key provided by a mobile payment application issuer, the trusted service manager, or a secure element issuer. Additionally, any other suitable encryption method using a mobile security application key may be implemented as one of ordinary skill would recognize. As such, the secure connection may be implemented using data encryption standards such as, e.g., RSA with a key of at least 1024 bits, triple data encryption standard (DES), 128-bit advanced encryption standard (AES), an RC4 stream encryption algorithm using minimum 128-bit key length, etc. These encryption standards may be used to create a secure session using the mobile security application key.

A “mobile payment application” may be an application providing payment capabilities implemented within a mobile device. For example, the mobile payment application may be installed in a secure element (SE) chip within a NFC-enabled portable communication device. The mobile payment application may be installed within a designated area of the secure element controlled by the mobile security application or may be installed in any available area on the secure element. The mobile payment application communicates with the mobile security application through any suitable means within the secure element. The mobile payment application provides the functionality to manage and maintain the consumer's payment information and support mobile payments. During a payment transaction, the mobile payment application may interact with an access device over the contactless interface to enable the mobile payment transaction. The mobile payment application may also support other modes of mobile payments, such as e-commerce, using the mobile communication device. The entity issuing the mobile payment application to the mobile communication device is typically a member of the payment processing network. In one embodiment, the entity issuing the mobile payment application is the issuer. The mobile payment application also interfaces with an unsecured application or mobile application (MA) on a mobile communication device.

A “secure element” may be a secure memory device such that the data contained on the secure element cannot easily be hacked, cracked, or obtained by an unauthorized entity. For example, the secure element may be an integrated circuit device that is implemented within a mobile communication device. The secure element may contain embedded smart card-grade applications (e.g., payment, transport, etc.). The secure element may be used by the mobile communication device to host and store data and applications that require a high degree of security. The secure element may be provided to the mobile communication device by the secure element issuer. Additionally, the secure element may be either embedded in the handset of the mobile communication device or in a subscriber identity module (SIM) card that may be removable from the mobile communication device. The secure element can also be included in an add-on device such as a micro-Secure Digital (microSD) card. The secure element may comprise a mobile security application associated with a processor, a key associated with a mobile security application, a first mobile payment application associated with the mobile security application, and a second mobile payment application associated with the mobile security application. The processor may be configured to use the key to encrypt a first communication between the first mobile payment application and a mobile gateway, and the processor may be further configured to use the key to encrypt a second communication between the second mobile payment application and the mobile gateway.

The secure element comprising a mobile security application “associated with a processor” may include some embodiments where the processor may be part of the secure element and thus the mobile security application is run by the processor in the secure element which uses the key to encrypt multiple communications. Alternatively, the processor may be electronically coupled to the secure element such that the processor may be associated with the mobile security application on the secure element but is not a part of the secure element. Instead, the processor could be a processor of the mobile communication device or another processor connected to the mobile communication device.

A “secure element key” can be an authentication key that is used in order to communicate with a secure element. The entity issuing/provisioning the mobile security application may need a secure element key and/or a token to install and personalize the mobile security application on the secure element. The secure element key may typically be determined and provided by the secure element issuer. However, the secure element key may generally be managed on the secure element issuer's behalf by a personalization bureau or trusted service manager. That is, these secure element keys may be provided by the secure element issuer to the trusted service manager prior to provisioning the mobile security application on the secure element. The secure element key may be used to ensure that the secure element is highly secure and that only entities that have the permission of the secure element issuer may communicate or access data on the secure element. A secure element issuer may set the secure element key and may provide the key to a trusted service manager so that the trusted service manager may communicate with the secure element.

A “secure element issuer” may be any entity that manufactures, designs, or provides a secure element. The secure element issuer may not necessarily be the fabricator of the secure element. Additionally, the secure element issuer may not necessarily be a member of the payment processing network or the same entity as the issuer of the payment instrument (e.g. mobile payment application on the mobile communication device). For example, the secure element issuer may be a mobile network operator (MNO).

An “unsecured application” can be an application that is stored in a memory element or unsecured computer readable medium on the mobile communication device. The application is unsecured because the data is stored on a memory element within the mobile communication device. Data stored on the memory element may be accessed by a third party as the data is not secured by the secure element key. The unsecured application may also be referred to as a mobile application (MA) and may provide a user interface between the user and the mobile payment application data stored on the secure element.

A “mobile application” may be an application that operates on the mobile communication device. The mobile application may provide a user interface for consumer interaction (e.g., to enter and view information) with the mobile security application and/or mobile payment applications. The mobile application also communicates with the mobile payment application to retrieve and return information during the processing of any of a number of services offered to the consumer via the mobile communication device (e.g., issuer update processing). Additionally, the mobile application can communicate with the mobile gateway to send and receive over-the-air (OTA) messages, however, the OTA messages may not be secured if the mobile application does not communicate through the mobile security application.

A “trusted service manager” may be an entity that offers services to support mobile financial services. The trusted service manager may provision or install the mobile security application on the secure element using over-the-air communications. The basic functionalities that may be provided by the trusted service manager include the ability to manage secure element keys for installing and configuring a mobile security application or a mobile payment application over the air. The trusted service manager may also be integrated with issuer systems for activating and personalizing the mobile security application or mobile payment application with consumers' payment information. Upon receiving an activation request, the trusted service manager may provision the mobile security application, mobile application, and may even provision a mobile payment application onto the designated secure element within a mobile communication device using over-the-air communications. The trusted service manager may also lock or unlock the secure element on the mobile communication device. Additionally, the trusted service manager may provide ongoing secure element platform management and support.

A “mobile gateway” can be a server computer or a series of server computers that are configured to communicate with mobile communication devices using over-the-air (OTA) messages. The mobile gateway allows mobile communication devices to access services from an issuer via the payment processing network, such as, e.g., issuer updates. Additionally, the mobile gateway allows mobile payment application issuers to communicate with mobile communication devices of consumers. Along with a key management center, the mobile gateway provides a secure channel over which information can be transmitted securely through the mobile communication device, over the mobile network, and/or over the Internet. Mobile gateways may be implemented by issuers, acquirers, third-party services providers, or trusted service managers.

“Account data” can be any form of information that is associated with a consumer financial or personal account. Account data may comprise an account number associated with a payment card issued by an issuer, a bank account number, checking account number, expiration data information, a pin number, or any other required information necessary to identify an account to a financial institution associated with the account. Furthermore, the account data may comprise account information that is recognizable by a payment transaction network as being a financial account. For example, the account data may comprise a bank identification number (BIN) so that the transaction processing system may identify which issuer or financial institution is associated with the account data.

A “first communication” and a “second communication” may include any exchange of information. For example, the first communication and the second communication may be a secure exchange of information between a mobile security application and a mobile gateway using a key associated with the mobile security application. The communications may be over-the-air (OTA) communications. The communications may comprise data packets, data streams, or any other suitable type of information transmission technique for communicating information between two entities. Additionally, the communications may be encrypted using a key associated with a mobile security application or provided by the mobile gateway. The key may implement any suitable form of encryption such that the communications may be secured. The communications may be initiated or utilized by a mobile payment application, mobile security application, mobile application (i.e. unsecured application), or by an issuer of a mobile payment application.

The communications may include information for configuring a mobile payment application as well as information for issuer updates to mobile payment applications. The issuer updates may include card parameter updates, blocking or unblocking of the mobile payment application, disabling the payment ability of a mobile payment application, and unblocking or changing a passcode used to authenticate the identity of the consumer and/or the mobile communication device. Additionally, the communications may include the delivery and request of value-added services provided by the mobile payment application issuer including inquires about balances of accounts corresponding to mobile payment applications, adding, limiting, or other instructions regarding pre-paid amounts associated with mobile payment applications, as well as requests and delivery of dynamic card verification values for use in card-not-present transactions. Accordingly, the first communication and the second communication may be selected from a group consisting of issuer application updates, balance updates, updating parameters for the mobile communication device, blocking a respective mobile payment application on the mobile communication device, unblocking the respective mobile payment application, disabling payment functionality on the mobile communication device, unblocking a passcode on the mobile communication device, changing the passcode on the mobile communication device, or setting the passcode to a default passcode.

Generally, embodiments of the present invention relate to apparatuses, systems, and methods of secure communications between mobile payment applications and issuers. In particular, some embodiments may provide a mobile security application stored in a secure element of a mobile communication device that uses a single key to communicate with two or more mobile payment applications and a mobile gateway. Additionally, some embodiments may provide secure communications for accounts stored on unsecured memory elements and accessed through unsecured applications.

### I. Exemplary Transaction System

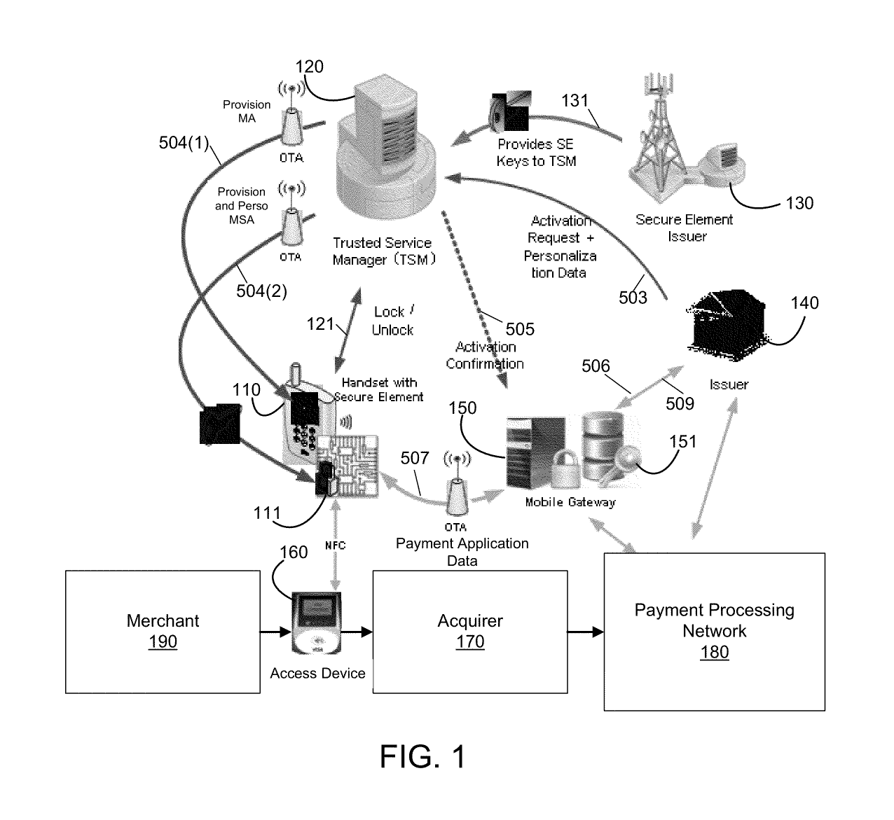

FIG. 1 depicts a transaction flow diagram within a mobile gateway 150 context. FIG. 1 shows entities involved in both a flow diagram for a transaction system as well as a provisioning and communication flow diagram for configuring and managing mobile security applications and mobile payment applications on a mobile communication device 110. For simplicity of discussion, only one of each component is shown. It is understood, however, that embodiments of the technology may include more than one of each component. Additionally, some embodiments of the technology may include fewer than all of the components shown in FIG. 1. Furthermore, the components in FIG. 1 may communicate via any suitable communication medium (including the Internet), using any suitable communication protocol.

FIG. 1 depicts an example of the system in which a mobile gateway 150 may be implemented. The system includes an access device 160, such as a contactless payment point-of-sale (POS) payment terminal, at a merchant 190 and an acquirer 170 associated with the merchant 190. In a typical payment transaction, a consumer may purchase goods or services at the merchant 190 via the access device 160 using a mobile communication device 110. The acquirer 170 can communicate with an issuer 140 via a payment processing network 180.

An “issuer” or “account issuer” can be any entity that issues and maintains a financial account for a consumer. For example, the issuer may be a bank. Note that the issuer 140 is most likely not the same entity as the secure element issuer 130 or the mobile security application issuer (not shown). Instead, the issuer 140 may issue a financial account and a mobile payment application associated with the financial account. Alternatively, the issuer 140 may not issue the mobile payment application directly and instead may contract with another party to issue the mobile payment application. The issuer 140 may communicate with the mobile gateway 150 regarding information related to the account associated with the mobile payment application.

A “payment processing network” may include data processing subsystems, networks, and operations used to support and deliver authorization services, exception file services, and clearing and settlement services. The payment processing network 180 may include data processing subsystems, networks, and operations used to support and deliver authorization services, exception file services, and clearing and settlement services. An exemplary payment processing network 180 may include VisaNet™. Payment processing networks such as VisaNet™ are able to process credit card transactions, debit card transactions, and other types of commercial transactions. VisaNet™, in particular includes a Visa Integrated Payments (VIP) system which processes authorization requests and a Base II system which performs clearing and settlement services. Furthermore, the payment processing network 180 may include a server computer and may use any suitable wired or wireless network, including the Internet.

Because the mobile communication device 110 can access services via the payment processing network 180 using the mobile gateway 150, the payment processing network 180 and the mobile gateway 150 may be provisioned so that they may work together. In one embodiment, the payment processing network 180 may provide the mobile gateway 150 with a client certificate that is presented during the establishment of a mutually-authenticated secure sockets layer (SSL) channel. The mobile gateway 150 may install and store this certificate in a key storage location. Any other suitable form of secured communication between the payment processing network 180 and the mobile gateway 150 may be implemented as one of ordinary skill would recognize.

A “server computer” can be a powerful computer or a cluster of computers. For example, the server computer can be a large mainframe, a minicomputer cluster, or a group of servers functioning as a unit. In one example, the server computer may be a database server coupled to a Web server.

The mobile communication device 110 may be in any suitable form for contactless payment. For example, suitable mobile communication devices 110 can be hand-held and compact so that they can fit into a consumer's wallet and/or pocket (e.g., pocket-sized). The mobile communication device 110 typically comprises a processor, a memory, input device, output devices, and near-field communication (NFC) devices, all of which are operatively coupled to the processor. Specific examples of mobile communication devices 110 can include cellular or wireless phones, tablets, smartphones, personal digital assistances (PDAs), pagers, portable computers, and the like. In some embodiments, the mobile communication device 110 may be associated with multiple financial accounts, such as being associated with different payment accounts (e.g., credit, debit, or prepaid). Likewise, it is possible for the consumer to have multiple mobile communication devices 110 that are associated with the same underlying financial account. Although a mobile communication device 110 is referred to in the present application, embodiments of the present invention could be implemented with a number of different mobile consumer devices capable of communicating with the entities described herein.

The merchant 190 can have, or may receive communications from, an access device 160 that can interact with the mobile communication device 110, such as a contactless POS device. The access device 160 according to embodiments of the technology can be in any suitable form for accessing data on a contactless mobile communication device 110. Examples of access devices 160 can include POS devices, cellular phones, PDAs, personal computers (PCs), tablet PCs, handheld specialized readers, set-top boxes, electronic cash registers, automated teller machines (ATMs), virtual cash registers, kiosks, security systems, access systems, and the like. The access device 160 may include any suitable contact or contactless mode of operation (e.g., radio frequency (RF) antennas, NFC devices, etc.).

In a typical purchase transaction, the consumer purchases a good or service via the merchant's 190 access device 160 using the mobile communication device 110. The mobile communication device 110 can interact with an access device 160 such as a contactless POS terminal at the merchant 190. For example, the consumer may take a wireless phone and may pass it near a contactless reader in a POS terminal.

An authorization request message is then forwarded from the access device 160 to an acquirer 170. An “acquirer” can be any bank that provides and maintains a financial account for the merchant 190. After receiving the authorization request message at the acquirer 170, the authorization request message is then sent to the payment processing network 180. The payment processing network 180 then forwards the authorization request message to the issuer 140 of the mobile communication device 110.

After the issuer 140 receives the authorization request message, the issuer 140 sends an authorization response message back to the payment processing network 180 to indicate whether or not the current transaction is authorized (or not authorized). The payment processing network 180 then forwards the authorization response message back to the acquirer 170. The acquirer 170 then sends the response message back to the merchant 190.

After the merchant 190 receives the authorization response message, the access device 160 at the merchant 190 may then provide the authorization response message for the consumer. The consumer may be an individual or an organization, such as a business that is capable of purchasing goods or services. The response message may be displayed by the access device 160 or may be printed out on a receipt.

At the end of the day, a normal clearing and settlement process can be conducted by the payment processing network 180. A clearing process is a process of exchanging financial details between an acquirer 170 and an issuer 140 to facilitate posting to a consumer's account and reconciliation of the consumer's settlement position. Clearing and settlement can occur simultaneously. Typically, the merchant 190 sends the clearance information to the acquirer 170 at the end of the day, and the acquirer 170 and issuer 140 can subsequently facilitate the clearing and settlement process.

### II. Exemplary Mobile Security Application Provisioning and Communication System

As described above, FIG. 1 shows an exemplary transaction system as well as an exemplary system for provisioning and communicating with a mobile security application on a mobile communication device 110. Although there are overlapping components and entities with the transaction system discussed above, the provisioning and communication system is directed to provisioning a mobile security application and communicating with the mobile security application in order to configure and maintain a plurality of mobile payment applications on a mobile communication device 110.

A mobile communication device 110 (e.g. mobile phone) may comprise a secure element 111, near-field communications hardware and software, and an antenna capable of communicating using any suitable communications scheme. The mobile communication device 110 may be capable of communicating with a trusted service manager (TSM) 120 and a mobile gateway 150 through one or more antennas using over-the-air (OTA) communications. Additionally, the mobile communication device 110 may be capable of communicating with an access device 160 (e.g. a contactless terminal) that may typically be located at a merchant 190 using contactless communications hardware.

The secure element 111 may be secured by a secure element key such that the secure element may not be communicated with or be capable of storing any data unless the correct secure element key is used during the communication with the secure element 111. The secure element key may be provided by a secure element issuer 130. The secure element issuer 130 may be a mobile network operator, mobile communication device manufacturer, or any other third party secure element manufacturer that determines a secure element key that will correspond to each issued secure element 111. The secure element issuer 130 may provide the secure element key to a trusted service manager 120 so that the trusted service manager 120 may control, monitor, and manage the secure element 111.

The trusted service manager 120 may communicate with the secure element 111 of the mobile communication device 110 through OTA communications (e.g. 504(1) and 504(2)). Typically, the trusted service manager 120 will be determined by a mobile network operator as their trusted service manager 120 for any mobile communication devices 110 that operate on their network. Accordingly, the secure element issuer 130 may provide the secure element keys that correspond to a particular mobile network operator to that mobile network operator's designated trusted service manager 120 (shown in step 131). The trusted service manager 120 may receive the secure element keys and store the secure element keys corresponding to each particular mobile communication device 110 comprising a secure element 111 from that secure element issuer 130. Alternatively, if more than one secure element 111 shares the secure element key (e.g. all the secure elements 111 issued from a particular secure element issuer 130 share the same secure element key) then the trusted service manager 120 may store the secure element key for all secure elements 111 issued by that particular secure element issuer 130. The trusted service manager 120 may use the secure element key to communicate through OTA messages with any particular mobile communication device 110 comprising a secure element 111 as long as the trusted service manager 120 has the corresponding secure element key.

The trusted service manager 120 may use the secure element key to provision a mobile security application on the secure element 111. The trusted service manager 120 may provision the mobile security application with a key associated with a mobile security application that may be used to encrypt communications between the mobile security application and any other entity (as shown in 504(2)). Alternatively the mobile security application may be provisioned on the secure element 111 by the secure element issuer 130 and may be provided a key before the trusted service manager 120 receives a secure element key for the secure element 111 (not shown). Furthermore, the mobile security application may be provisioned at the chip level by embedding the mobile security application on the secure element 111 by the secure element manufacturer (not shown).

Once the mobile security application is provisioned on the secure element 111, the trusted service manager 120 (or whoever provisions the mobile security application) may provide an activation confirmation to the mobile gateway 150 (step 505). If the mobile security application key is provided by the trusted service manager 120 or whoever provisioned the mobile security application, the mobile security application key may be provided to the mobile gateway 150 during the activation confirmation or may be provided at any other time. The activation confirmation message may be encrypted such that the mobile security application key is not intercepted by a malicious or unintended entity.

Additionally, the trusted service manager 120 may communicate and control the secure element 111. The trusted service manager 120 may send lock and unlock commands to the secure element 111 through OTA communications using the secure element key that may enable or disable the secure element 111 from use (step 121). Additionally, in some embodiments, the trusted service manager 120 may provision and personalize the secure element 111 with mobile payment applications through the mobile security application or may directly provision and personalize the secure element 111 with mobile payment applications from account issuers 140 (step 504(2)). Additionally, the trusted service manager 120 may provision and personalize the mobile communication device 110 with the mobile application 112 (i.e. unsecured application) (step 504(1)). The mobile application 112 or unsecured application may also be provided by any other suitable entity as one of ordinary skill would recognize.

The mobile gateway 150 can be used when OTA messages need to be sent between the mobile communication device 110 and an entity (e.g. an issuer 140 of a mobile payment application). The mobile gateway 150 provides the link to mobile communication devices 110 over which services can be offered by entities such as account issuers 140, payment processing networks 180, and other processors. Upon successful provisioning of the mobile security application, the mobile gateway 150 may communicate with the mobile security application using secure communications to configure, update, or maintain a plurality of mobile payment applications for a number of different account issuers 140 (as shown in step 507). A mobile security application key may be used to generate a secure communication channel that may allow the mobile communication device 110 to securely access services provided by the payment processing network 180, account issuers 140, or any other entities that have an interest in communicating with the mobile security application. The mobile security application key may be provided and stored on the secure element 111 by the trusted service manager 120 during provisioning and then provided to the mobile gateway 150. Alternatively, the mobile security application key may be stored at the mobile gateway 150 and a separate encryption scheme may be provided during an authentication between the mobile security application and the mobile gateway 150. The mobile gateway 150 may comprise a key management center 151 that stores keys for all of the mobile communication devices 110 in which it has received confirmation of mobile security application activation.

In some embodiments, it may be possible to implement the key management center 151 and the mobile security application such that the mobile security application key is a session key that changes after each authentication of the mobile security application with the mobile gateway 150. A similar process is described in U.S. patent application Ser. No. 13/075,592, to Aabye et al., filed Mar. 30, 2011, which is hereby incorporated by reference in its entirety.

The account issuer 140 (“Issuer”) may communicate with the mobile gateway 150 to update any mobile payment application that has been configured on the mobile security application. The communications between the issuer 140 and the mobile gateway 150 may be secured through any suitable manner including an encryption key associated with the mobile gateway 150. Additionally, the identification of the mobile communication device 110 may occur through any suitable means. For example, when a mobile payment application is configured on a mobile communication device 110, the mobile gateway 150 and subsequently the issuer 140 may receive mobile payment application data identifying the mobile communication device 110, secure element 111, mobile security application, or any other identifier that may be used to identify the particular mobile communication device 110 comprising the mobile payment application.

Communications between the mobile communication device 110, mobile gateway 150, and the issuer 140 may be initiated by any entity within the system. For example, the mobile payment application, the consumer, the mobile security application, or the mobile gateway 150 may determine that the issuer 140 needs to update or provide some data to the mobile payment application and may initiate a communication with the issuer 140. Alternatively, the issuer 140, the mobile gateway 150, the consumer, or the mobile security application may determine that the mobile payment application needs to provide some data to the issuer 140 in order to update, configure, or secure the mobile payment application or issuer system 140.

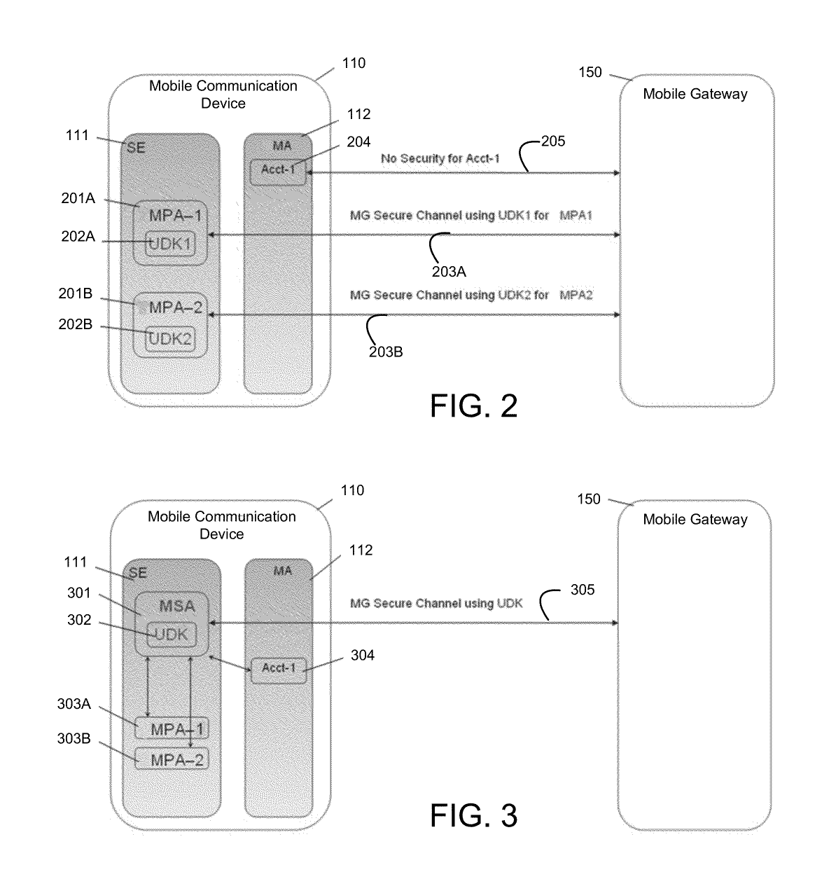

FIG. 2 illustrates a diagram of a mobile communication device 110 comprising two mobile payment applications, MPA-1 201A and MPA-2 201B, communicating with a mobile gateway 150 using two separate encryption keys, UDK1 202A and UDK2 202B, to create two separate secure channels 203A, 203B. Additionally, FIG. 2 illustrates a mobile communication device 110 in communication with a mobile gateway 150 over an unsecure channel 205. Information exchanged over the unsecure channel 205 may be intercepted by a malicious third party and if not intercepted during transmission, any information stored on the mobile communication device 110 may be obtained from the unsecured memory element. The transaction flow diagram described in FIG. 2 shows how mobile payment applications, MPA-1 201A and MPA-2 201B, communicate with a mobile gateway 150 without the use of a mobile security application (not shown).

The mobile payment applications, MPA-1 201A and MPA-2 201B, are payment applications that are installed in a secure element (SE) chip 111 within a NFC-enabled mobile communication device 110. The secure element 111 can have any number of mobile payment applications 201A-201B. Each mobile payment application, MPA-1 201A and MPA-2 201B, is associated with a different financial account of the consumer associated with an account issuer 140. Additionally, the accounts could be associated with two different account issuers (not shown). In the example of FIG. 2, a first mobile payment application MPA-1 201A and a second mobile payment application MPA-2 201B provide the functionality to manage and maintain the consumer's payment information and support mobile contactless payments. During a payment transaction, either of the two mobile payment applications, MPA-1 201A or MPA-2 201B, can interact with the access device 160 over the contactless interface to enable the payment transaction.

Both mobile payment applications, MPA-1 201A and MPA-2 201A, are also configured to interface with the mobile application (MA) 112 on the mobile communication device 110. The mobile application MA 112 is an unsecured application that provides a user interface for consumer interaction (e.g., to enter and view information for an account such as Acct-1 204). Acct-1 204 may be any account that does not have a specific mobile payment application designed for it. Typically these accounts may not be associated with a card issuer and instead may be related to a bank account or other non-card related account for the consumer (e.g. a Paypal™ account, etc.). The mobile application MA 112 may also communicate with the mobile payment applications, MPA-1 201A and MPA-2 201B, to retrieve and return information during the processing of any of a number of services offered to the consumer via the mobile communication device 110 including issuer update processing (not shown). Additionally, the mobile application MA 112 can communicate with the mobile gateway 150 to send and receive over-the-air messages. However, only communications originating from the mobile payment applications, MPA-1 201A and MPA-2 201B, may be encrypted and secured from interception over the air or subversion from the memory element by a malicious third party.

The mobile payment applications, MPA-1 201A and MPA-2 201B, may use data encryption standards such as, e.g., RSA with a key of at least 1024 bits, triple data encryption standard (DES), 128-bit advanced encryption standard (AES), an RC4 stream encryption algorithm using minimum 128-bit key length, etc., when communicating with the mobile gateway 150. These encryption standards may be used to create the first secure channel and the second secure channel for each respective mobile payment application 201A, 201B.

As explained above, the mobile payment applications, MPA-1 201A and MPA-2 201B, can be installed within the secure element 111 to manage and maintain the security of payments and payment account information. The entity issuing each mobile payment application (i.e. an account issuer 140 or an agent of the account issuer 140) may need a secure element key and/or a token to install and personalize the mobile payment application on the secure element 111. The secure element keys may originally be provided by the secure element issuer 130 to a trusted service manager 120 so that the provisioning or installation of the mobile payment applications may be managed on the issuer's 140 behalf by a personalization bureau or trusted service manager 120.

In the embodiment depicted in FIG. 2, each mobile payment application, MPA-1 201A and MPA-2 201B, is authenticated with the mobile gateway 150 using its own unique derivation key (UDK1 202A and UDK2 202B, respectively), and a secure channel is created for each mobile payment application upon successful authentication 203A, 203B. Each UDK may be provided by the mobile gateway 150 upon authentication or in some embodiments, the UDK 202A, 202B may be provided to the mobile payment application 201A, 201B when the mobile payment application 201A, 201 B is provisioned on the secure element 111 by the trusted service manager 120. Either way, the mobile gateway 150 may track, store, and manage a different key for each and every mobile payment application 201A, 201B provisioned on the secure element 111 of the mobile communication device 110. Additionally, each mobile payment application may be provisioned by a trusted service manager 120 that has a secure element key for accessing the secure element 111. Accordingly, the management and initialization of mobile payment applications 201A, 201B in the embodiment provided in FIG. 2 may generate a substantial amount of logistical difficulties surrounding management and installation of mobile payment applications 201A, 201B and their corresponding UDK keys 202A, 202B.

Additionally, because mobile payment applications may be designed and provisioned by an account issuer 140, the mobile payment applications 201A, 201B are only directed to accounts that correspond to credit or debit cards. Accordingly, if a user wants access to a financial account that is not associated with a credit or debit card (e.g. a bank account), any information transmitted between the mobile application 112 and the mobile gateway 150 will not be secured through the secure element 111 (as shown in communication 205). Accordingly, the information is not secured and may be intercepted or stolen by a malicious or unintended third party as shown in the unsecured communication of element 205.

FIG. 3 depicts a transaction flow diagram for communicating with multiple mobile payment applications, MPA-1 303A and MPA-2 303B, using an exemplary embodiment of a mobile security application 301. Similar to the mobile communication device in FIG. 2, the transaction flow in FIG. 3 illustrates two mobile payment applications, MPA-1 303A and MPA-2 303B, on a mobile communication device 110. However, in FIG. 3, a mobile security application (MSA) 301 may be used to authenticate any number of mobile payment applications 303A, 303B using a single mobile security application key 302 (e.g. UDK). FIG. 3 shows a mobile communication device 110 that is a mobile phone and comprises a secure element 111. The mobile security application 301, the first mobile payment application 303A, and the second mobile payment application 303B are stored in a secure element 111 in the mobile communication device 110. Additionally, the mobile communication device 110 further comprises an unsecured application (mobile application 112), wherein the multiple communications may utilize the unsecured application 111, wherein the unsecured application 112 comprises account data that may be sent to the mobile gateway 150 via the mobile security application 301.

Similar to the process described above in relation to the mobile payment applications, the mobile security application 301 may authenticate the mobile communication device 110 to the mobile gateway 150. The mobile security application 301 is authenticated with the mobile gateway 150 using the mobile security application key 302 which may be a unique derivation key (UDK 302) and a secure channel 305 is created for the mobile security application 301 upon successful authentication. The mobile security application key 302 (e.g. the UDK in this example) may be provided by the mobile gateway 150 upon authentication or in some embodiments, the key 302 may be provided to the mobile security application 301 when the mobile security application 301 is provisioned on the secure element 111 by the trusted service manager 120. Additionally, in some embodiments, a passcode may be used to authenticate the user and the mobile communication device 110 to the mobile gateway 150 prior to creating the secure channel 305. Once the mobile security application 301 authenticates the mobile communication device 110 with the mobile gateway 150, a secure channel 305 can be generated using the key 302 (e.g. UDK) associated with the mobile security application 301 and the secure channel 305 can be used to provide secure communications between one or more mobile payment applications 303A, 303B.

As discussed above, the mobile security application 301 may be provisioned by a trusted service manager 120 on the secure element 111 of the mobile communication device 110. Once provisioned or installed on the secure element 111, the mobile security application 301 may be provided or have access to an amount of available data space on the secure element 111 that the mobile security application 301 can use to securely store any information received from the mobile gateway 150. Accordingly, the mobile security application 301 may receive account data associated with a mobile payment application 303A, 303B from an account issuer 140 and may configure the mobile payment application 303, 303B in the available secure storage data provided to the mobile security application 301 during provisioning. Accordingly, the mobile security application 301 may configure multiple mobile payment applications 303A, 303B from a number of different account issuers 140 without having to contact a trusted service manager 120 to gain access to the secure element 111.

Additionally, since only one authentication key (e.g. UDK) 302 is necessary and the key 302 is already associated with the mobile security application 301, the individual mobile payment applications 303A, 303B do not need to store a key or information related to processing a secure communication using a key. Accordingly, the mobile payment applications 303A, 303B may be implemented using less data, resulting in less time to configure the applications and less secure element space being used to implement the same number of mobile payment applications 303A, 303B as the mobile payment applications 201A, 201B of FIG. 2. Accordingly, more mobile payment applications 303A, 303B may be implemented on the secure element 111 using less storage space. This is desirable because space on the secure element 111 is limited and is generally rented or bought from the secure element issuer 130 or mobile network operator.

Additionally, the mobile security application 301 may be used to secure communications for non-card based accounts (e.g. ACCT-1 304) that previously could not be secured using the secure element 111. The mobile security application 301 may secure these communications and the subsequent account by either generating a mobile payment application 303A, 303B data entry that is similar to the mobile payment applications 303A, 303B but corresponding to the bank account (not shown) on the secure element 111. Alternatively, the mobile security application 301 may communicate with the account data (ACCT-1 304) stored in the memory element so that the communications may be secured just as with the mobile payment applications 303A, 303B. Unlike the mobile payment applications of FIG. 2, the mobile security application 301 has a dedicated key associated with the mobile security application 301 and as such, the key 302 associated with the mobile security application 301 can be used to communicate with non-card based accounts (e.g. ACCT-1 304) stored on the unsecured memory element through the mobile or unsecured application 112. The UDK 302 is not associated with the digital card information and thus, can be used to communicate with any type of data. The account data (ACCT-1 304) may be stored in the mobile security application 301 so that any data shared with the mobile gateway 150 is secured.

Once the secure channel 305 is successfully prepared and established, communication can occur between the mobile communication device 110 and a first entity (not shown). The first entity can be any entity using a secure channel 305 for over-the-air communication with the mobile communication device 110. After the successful establishment of a secure channel, the mobile communication device 110 may construct a message that contains secure element 111 chip data to the first entity and send the message to the mobile gateway 150. The mobile gateway 150 may then construct and forward the appropriate request to the first entity. The mobile gateway 150 may need to construct the request message in a manner that the first entity can understand. When the mobile gateway 150 receives a response from the first entity, the mobile gateway 150 may translate the response from the first entity into an over-the-air message to be returned to the mobile communication device 110. This process is explained in further detail below.

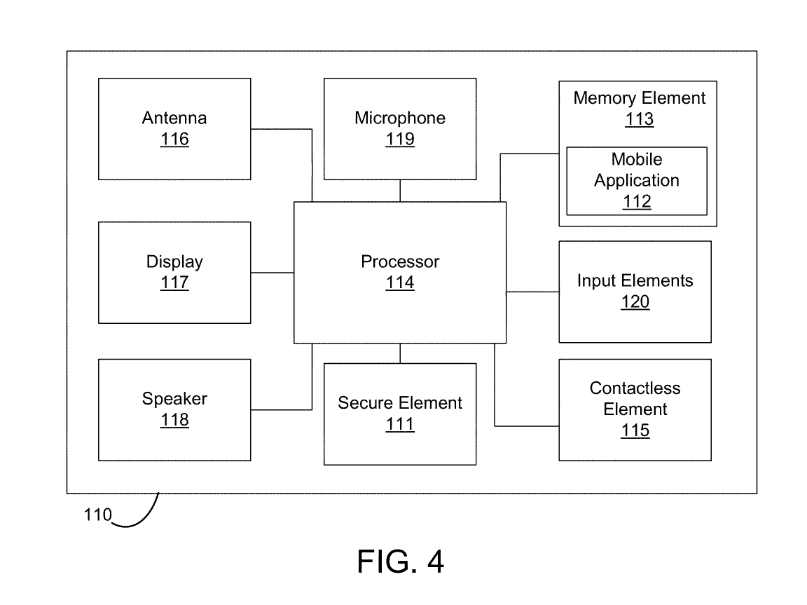

FIG. 4 depicts a block diagram of an exemplary mobile communication device 110. The mobile communication device 110 may comprise a memory element 113 (i.e. computer readable medium) and a body 110(a) as shown in FIG. 4. (FIG. 4 shows a number of components, and the mobile communication devices 110 according to embodiments of the invention may comprise any suitable combination or subset of such components.) The memory element 113 may be present within the body 110(a), or may be detachable from it. The body 110(a) may be in the form a plastic substrate, housing, or other structure. The memory element 113 may be a memory that stores data and may be in any suitable form including a magnetic stripe, a memory chip, uniquely derived keys (such as those described above), encryption algorithms, etc.

The memory element 113 may comprise code executable by a processor for a mobile application 112. As described above, the mobile application 112 may be an application that operates on the mobile communication device 110 that provides a user interface for consumer interaction (e.g., to enter and view information) with the mobile security application 301 and/or mobile payment applications 303A, 303B. The mobile application 112 may also communicate with mobile payment applications 303A, 303B to retrieve and return information during the processing of any of a number of services offered to the consumer via the mobile communication device 110 (e.g., issuer update processing). Additionally, the mobile application 112 can communicate with the mobile gateway 150 to send and receive over-the-air (OTA) messages, however, the OTA messages may not be secured if the mobile application 112 does not communicate through the mobile security application 301.

The memory element 113 may also store information such as financial information, transit information (e.g., as in a subway or train pass), access information (e.g., as in access badges), etc. Financial information may include information such as bank account information, bank identification number (BIN), credit or debit card number information, account balance information, expiration date, consumer information such as name, date of birth, etc. Any of this information may be transmitted by the mobile communication device 110. Furthermore, mobile communication device 110 may also include the secure element 111, as described above.

Information in the memory element 113 may also be in the form of data tracks that are traditionally associated with credits cards. Such tracks include Track 1 and Track 2. Track 1 (“International Air Transport Association”) stores more information than Track 2, and contains the cardholder's name as well as account number and other discretionary data. This track is sometimes used by the airlines when securing reservations with a credit card. Track 2 (“American Banking Association”) is currently most commonly used. This is the track that is read by ATMs and credit card checkers. The ABA (American Banking Association) designed the specifications of this track and all world banks must abide by it. It contains the cardholder's account, encrypted PIN, plus other discretionary data.

The secure element 111 may be a secure memory on the mobile communication device 110 such that the data contained on the secure element 111 cannot easily be hacked, cracked, or obtained by an unauthorized entity. The secure element 111 is used by the mobile communication device 1110 to host and store data and applications that use a high degree of security. The secure element 111 is provided to the mobile communication device 110 by the secure element issuer. The secure element 111 may be either embedded in the handset of the mobile communication device 110 or in a subscriber identity module (SIM) card that may be removable from the mobile communication device 110. The secure element 111 can also be included in an add-on device such as a micro-Secure Digital (microSD) card.

The secure element 111 may also store the same information the memory element may store such as financial information, transit information (e.g., as in a subway or train pass), access information (e.g., as in access badges), etc. Financial information may include information such as bank account information, bank identification number (BIN), credit or debit card number information, account balance information, expiration date, consumer information such as name, date of birth, etc. Preferably, sensitive information including financial information, account information, personal information, etc. may be stored in the secure element 111 to ensure the data is secure from a malicious third party.

Information in the secure element 111 may also be in the form of data tracks that are traditionally associated with credits cards. Such tracks include Track 1 and Track 2. Track 1 (“International Air Transport Association”) stores more information than Track 2, and contains the cardholder's name as well as account number and other discretionary data. This track is sometimes used by the airlines when securing reservations with a credit card. Track 2 (“American Banking Association”) is currently most commonly used. This is the track that is read by ATMs and credit card checkers. The ABA (American Banking Association) designed the specifications of this track and all world banks must abide by it. It contains the cardholder's account, encrypted PIN, plus other discretionary data. Additionally, the information in the secure element 111 may be in any other suitable form such that the mobile payment applications may use the information to initiate a transaction.

Accordingly, the secure element may comprise a mobile security application associated with a processor, a key associated with a mobile security application, a first mobile payment application associated with the mobile security application, and a second mobile payment application associated with the mobile security application, wherein the processor is configured to use the key to encrypt a first communication between the first mobile payment application and a mobile gateway, and wherein the processor is further configured to use the key to encrypt a second communication between the second mobile payment application and the mobile gateway. As explained previously, the secure element comprising a mobile security application “associated with the processor” may mean that the processor is a part of or is integrated into the secure element. Alternatively, the mobile security application being “associated with the processor” may mean that the processor is electrically connected or electrically coupled to the secure element such that the processor is not physically located in the secure element but may access the information contained on the secure element and use the key to encrypt the communications between the mobile payment applications and the mobile gateway.

The mobile communication device 110 may further include a contactless element 115, which is typically implemented in the form of a semiconductor chip (or other data storage element) with an associated wireless transfer (e.g., data transmission) element, such as an antenna. Contactless element 115 is associated with (e.g., embedded within) mobile communication device 110 and data or control instructions transmitted via a cellular network may be applied to contactless element 115 by means of a contactless element interface (not shown). The contactless element interface functions to permit the exchange of data and/or control instructions between the mobile communication device circuitry (and hence the cellular network) and an optional contactless element 115.

Contactless element 115 is capable of transferring and receiving data using a NFC capability (or NFC medium) typically in accordance with a standardized protocol or data transfer mechanism (e.g., ISO 14443/NFC). Mobile communication devices 110 that support mobile contactless payments typically support contactless transactions using the EMV contactless communication protocol (EMV-CCP), which is based on ISO 14443, in order to interact with merchant access devices. This capability is typically met by implementing NFC. The NFC capability on the mobile communication device 110 might be enabled by an embedded NFC chip or by the addition of an external memory card or accessory that contains the NFC chip. NFC capability is a short-range communications capability, such as RFID, Bluetooth™, infra-red, or other data transfer capability that can be used to exchange data between the mobile communication device 110 and an interrogation device. Thus, the mobile communication device 110 is capable of communicating and transferring data and/or control instructions via both cellular network and near-field communications capability.

The mobile communication device 110 may also include a processor 114 (e.g., a microprocessor) for processing the functions of the mobile communication device 110 and a display 117 to allow a consumer to see phone numbers and other information and messages. The mobile communication device 110 may further include input elements 120 to allow a consumer to input information into the device, a speaker 118 to allow the consumer to hear voice communication, music, etc., and a microphone 119 to allow the consumer to transmit his or her voice through the mobile communication device 110. The mobile communication device 110 may also include an antenna 116 for wireless data transfer (e.g., data transmission).

### III. Exemplary Methods

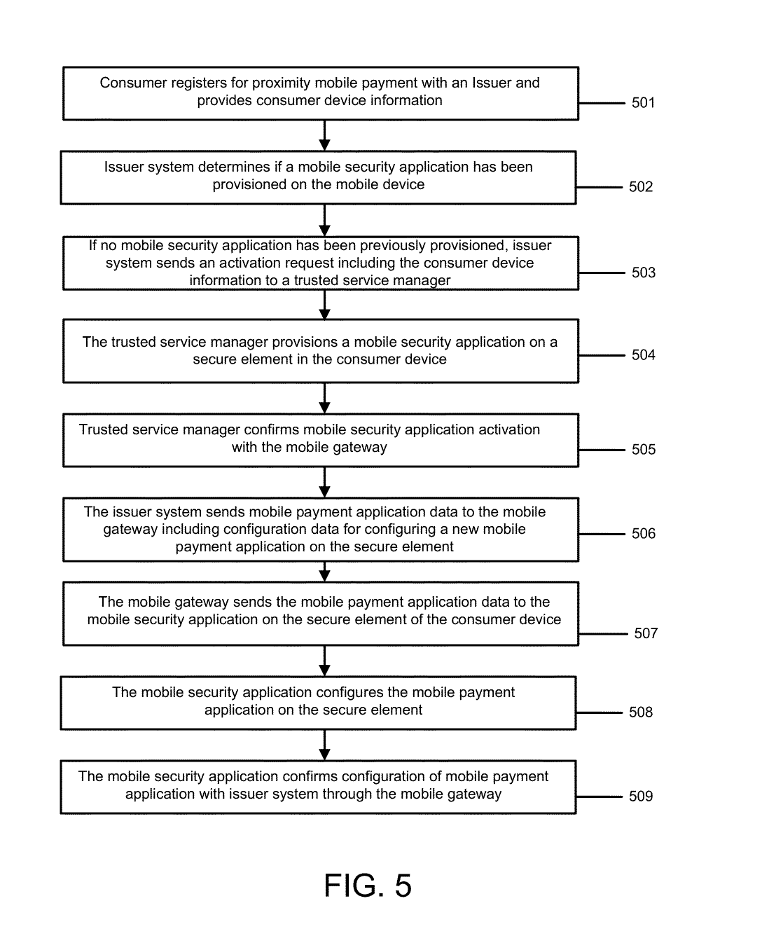

FIG. 5 illustrates an exemplary flow diagram for configuring or provisioning one of a possible plurality of multiple payment applications on a mobile communication device 110 using a mobile security application. The provisioning of the mobile communication device 110 may be initiated with or without a consumers' action based on the issuer's 140 business requirements.

In step 501 of FIG. 5, the consumer 102 may register for the contactless mobile payment service with an issuer 140. The issuer system 140 processes this request and takes appropriate action. During registration, the consumer may provide mobile communication device information that the user will be using to perform the contactless mobile payment service. The issuer 140 may have an agreement with a mobile security application provider, a mobile gateway operator, a trusted service manager 120, or other third party to provide the mobile security application to the consumer or may provide a mobile security application 301 to the consumer directly.

In step 502, the issuer system 140 may determine if a mobile security application 301 has been previously provisioned on the mobile communication device 110. The issuer 140 may have a database of registered customers with provisioned mobile communication devices 110 listed, may send a message to the mobile gateway 150 to determine if the mobile gateway 150 has such a record, or may inquire with an appropriate trusted service manager 120 or secure element issuer 130 for the mobile communication device 110 to determine if the mobile security application 301 has previously been provisioned. If the issuer system 140 determines that a mobile security application 301 has been previously provisioned on the mobile communication device 110, the issuer 140 may obtain the mobile security application's 301 identification information and skip to step 506 below. However, if no mobile security application 301 has been previously provisioned on the secure element 111 of the mobile communication device 110, the issuer system 140 may initiate a provisioning of the mobile security application 301.

In step 503, the issuer system 140 sends an activation request to a trusted service manager 120 associated with the secure element 111 of the mobile communication device 110 including the appropriate provisioning data. The provisioning data may include information related to the consumer, the mobile communication device 110, and/or the secure element 111 so that the trusted service manager can identify and contact the mobile communication device 110 and subsequently the secure element 111 to provision the mobile security application.

In step 504, the trusted service manager 120 processes the issuer 140 activation request and performs the provisioning of a mobile security application 301 on the secure element 111 of the mobile communication device 110 (shown as 504(2) in FIG. 1). The trusted service manager 120 may also provision a mobile application 112 on the memory element of the mobile communication device 110 (shown as 504(1) in FIG. 1) as well as provisioning a mobile payment application on the secure element 111. However, the provisioning of the mobile payment application and the mobile application through the trusted service manager 120 is not necessary and will likely be more costly, inefficient, and complicated to perform through the trusted service manager 120. As such, typically the trusted service manager 120 will only provision the mobile security application 301 if it has not previously been provisioned and the issuer 140 will configure and update the mobile payment application and mobile application through the mobile gateway 150.

In step 505, the trusted service manager 120 confirms that activation of the mobile security application 301 is complete with the mobile gateway 150. Once a mobile security application 301 is activated, the trusted service manager 120 may send an activation confirmation to the mobile gateway 150. The trusted service manager 120 may include mobile security application identification and subscriber information, including the mobile security application key (if provided by the trusted service manager 120), in the confirmation with the mobile gateway 150. The mobile gateway 150 may also optionally communicate some or all of this information to the issuer system 140 so the issuer system 140 can update their consumer records to indicate a mobile security application 301 has been provisioned and the mobile security application identifier for the consumer. For example, the mobile security application key would not be provided to the issuer system 140 for security reasons. Updating information related to provisioning and deleting different mobile security applications 301 or provisioning the mobile security application 301 on a different secure element 111 may happen in the same manner as the provisioning process described above.

In step 506, the issuer 140 may receive confirmation that the mobile payment application has been previously provisioned on the mobile communication device 110 and may send mobile payment application data to a mobile gateway 150. The mobile payment application data may comprise configuration data for configuring a new mobile payment application on the secure element 111.

In step 507, the mobile gateway 150 determines the mobile security application 301 information for the consumer including the mobile payment application key (e.g. UDK). As explained above, the mobile security application key (e.g. UDK) may be stored on the mobile security application 301 in the secure element 111 or may be provided to the mobile gateway 150. Either way, a secure channel 305 is generated between the mobile gateway 150 and the mobile security application 301 using the mobile security application key to encrypt the communications between the entities.

The mobile gateway 150 may use a key management center 151 to set up a secure mutually authenticated channel 305 with the mobile security application 301 in the mobile communication device 110. As part of this process, the key associated with the mobile security application 301 may be used to enable the authentication of the mobile security application 301 to the key management center 151. In typical systems, each mobile security application 301 is personalized with unique keys (UDKs) derived from a mobile security application 301 issuer-specific set of master keys (MDKs). These master keys may be shared between the mobile security application 301 issuer system (not shown) and the key management center 151. The mobile security application keys may be different from the keys used for authenticating chip payment transactions or issuer scripts and are used for the purpose of establishing the secure channel. The account issuer system 140 does not require any access to these cryptographic keys for establishing the secure channel 305. Instead, the mobile gateway 150 may maintain the key associated with the mobile security application 301 and use separate encryption keys to communicate with the account issuers 140.

Once the secure channel is successfully prepared and established, communication can occur between the mobile communication device 110 and a first account issuer 140. A communication may occur by the first mobile payment application 303A in the mobile communication device 110 with the mobile gateway 150 wherein the communication is encrypted using the key. The mobile communication device 110 may communicate by constructing a message that contains secure element 111 chip data, a mobile security application identifier, a mobile payment application identifier, an account identifier, or any other identification information to the first account issuer 140 so that the first account issuer 140 may determine which account the communication relates to. The mobile payment application 303A can then send the message to the mobile security application 301, which can encrypt the message using the mobile security application key and send the message to the mobile gateway 150. The mobile gateway 150 may then construct and forward the appropriate request to the first account issuer 140. The mobile gateway 150 may need to construct the request message in a manner that the first account issuer 140 can understand.

When the mobile gateway 150 receives a response from the first account issuer 140, the mobile gateway 150 may translate the response from the first account issuer into an OTA message to be returned to the mobile communication device 110 and subsequently the mobile security application 301, and the appropriate mobile payment application 303A. Again, the communication may comprise the appropriate identifier for the mobile payment application 303A such that the mobile gateway 150 knows which mobile communication device 110 to communicate with and the mobile security application 301 knows which mobile payment application 303A to apply the changes to.

Alternatively, the first account issuer 140 may initiate the communication with the mobile communication device 110 as well by sending a message to the mobile gateway 150 prior to the mobile payment application 303A constructing the message. The issuer communication may include a mobile payment application identifier or any other identification information such that the mobile security application 301 may determine which mobile payment application 303A, 303B is being addressed.

In step 508, the mobile security application 301 configures the mobile payment application on the secure element 111. As explained above, the mobile security application 301 is provided with a predetermined amount of data space in the secure element 111 and may store the mobile payment application 303A, 303B information in the provided secure space. As such, a number of mobile payment applications 303A, 303B may be provisioned or configured on the secure element 111 without requiring a trusted service manager 120 to provision the mobile payment applications 303A, 303B individually.

Finally, in step 509, the mobile security application 301 confirms the successful configuration of the mobile payment application with the issuer system 140 through communicating with the mobile gateway 150. The confirmation message may include any suitable data including a mobile payment application identifier, account data associated with the mobile payment application, consumer information, authentication information, challenge-response information to be used in the future, or any other suitable data the issuer 140 or mobile gateway 150 may use to identify, communicate, or maintain the mobile payment application on the secure element 111 in the future.

Steps 506-509 may be repeated by the issuer 140 whenever an issuer update or other maintenance is initiated for the mobile payment application. Additionally, the mobile payment application may also initiate communication with the issuer 140 using a similar process as steps 506-509.

For example, in one embodiment, the first account issuer 140 may wish to control and/or update a first mobile payment application 303A on the mobile communication device 110. For example, the first issuer 140 may wish to update the first mobile payment application 303A with additional information associated with the payment account of the consumer. For example, the mobile communication device 110 may request an update for the first mobile payment application 303A when offline risk counters and indicators in the mobile application MA 112 have reached certain thresholds, such that the mobile payment application 303A triggers a mobile update request, when an issuer 140 sends a ‘talk-to-me’ push notification, etc. For issuer updates, the mobile gateway 150 is used to establish the secure connection between the first mobile payment application 303A and the associated issuer 140 to enable the delivery of the updates. The updates can further include, but are not limited to, card parameter updates, blocking or unblocking the mobile payment application 154, disabling payment ability, unblocking or changing the passcode for the mobile payment application 154, setting the passcode for authenticating a user to a default passcode, etc.

In addition to the capability to control and/or update the mobile payment application 154, the issuer 140 may provide additional features for value-added services. The issuer 140 may allow the consumer to inquire about one or more of their balances, and the issuer 140 may provide the one or more balances to the mobile communication device 110 over the secure channel. The issuer 140 may provide a message indicating top-up or add additional funds to a prepaid payment account associated with the mobile communication device 110 over the secure channel using a funding account linked to the prepaid payment account. The issuer 140 may also process a request for and provide a dynamic card verification value 2 (CVV2) for use in card-not-present (CNP) transactions.

Although embodiments of the present invention are described in reference to provisioning mobile payment applications 303A, 303B on a secure element 111 and providing issuer updates between a mobile communication device 110 and a mobile payment application issuer 140, one of ordinary skill in the art would recognize that embodiments of the present invention are not limited to such examples.

Embodiments of the present invention can be implemented to conduct any communication between a secure element and a first entity. For example, the first entity may be a security firm that provides a security password to the secure element before each transaction to verify that no theft of the mobile communication device has been reported prior to allowing a transaction. Another embodiment of the present invention may include the communication of a pseudo primary account identifier corresponding to the consumer's account information to the secure element from a payment processing network during a transaction to ensure that the consumer's account number will not be transmitted during transactions. Accordingly, embodiments of the present invention may be implemented to complete secure communications between a secure element and any entity before, during, or after a transaction with any merchant, government agency, transit system, or any other service provider.

### IV. Technical Advantages

Embodiments of the present technology provide a number of technical advantages. The mobile security application provides simple key management as only a single key is required for use with multiple mobile payment applications instead of separate keys being needed for each mobile payment application on a mobile communication device. Additionally, the mobile security application provides increased security as

The mobile security application (MSA) provides secure communication with the mobile gateway using a single UDK encryption key and creates a secure channel for provisioning multiple accounts that may be used to process transactions with any number of different payment accounts, including bank accounts which previously could not be secured. Additionally, transaction costs are minimized because the mobile security application minimizes the necessity for secure element provisioning by network operators and the amount of space required on a secure element. Allowing an issuer system to communicate with the mobile gateway and provide the issuer updates and mobile payment application configuration directly is more efficient, less costly, and less time consuming than requiring a third party trusted service manager to individually provision and configure each mobile payment application on the secure element.

Additionally, technical advantages are provided by simplifying the management of personalized keys and implementing a single provisioning step for a number of payment applications on a secure memory of a mobile communication device. Fewer keys mean less complex management solutions and fewer system resources expended managing keys. Additionally, the mobile security application protects accounts that previously were not able to perform secure payments through the secure memory, providing additional account security.

Additionally, the techniques described above provide a consumer-centric approach to mobile payment application maintenance and upgrading, requiring the consumer to authenticate the mobile communication device once for any number of mobile payment applications on the secure element. Furthermore, the UDKs may only need to be exposed to the trusted service manager during mobile security application provisioning, thus opening the UDKs to less possibility of interception. Additionally, a mobile payment application can be transported to another mobile security application securely via the mobile gateway and/or trusted service manager as needed.

Finally, since only one authentication key is necessary and it is already determined by the mobile security application, the individual mobile payment applications may be smaller and simpler to implement. Accordingly, more mobile payment applications may be implemented on the secure element using less storage space. This is desirable because space on the secure element is limited and is generally rented or bought from the secure element issuer or the mobile network operator.

The various participants and elements, such as, e.g., the mobile gateway, described herein with reference to the figures may operate one or more computer apparatuses to facilitate the functions described herein. Any of the elements in the figures, including any servers or databases, may use any suitable number of subsystems to facilitate the functions described herein.

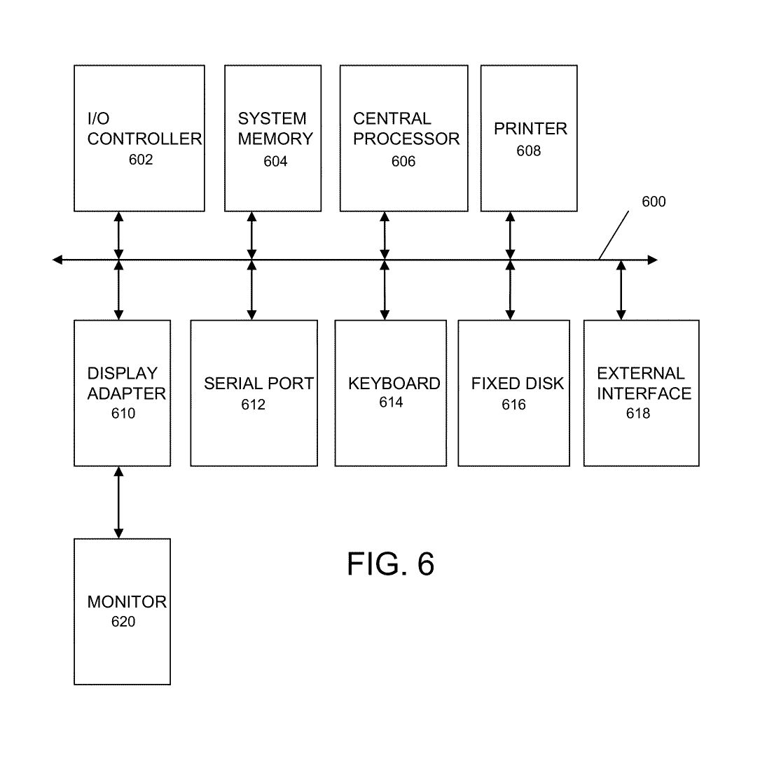

Examples of such subsystems or components are shown in FIG. 6. The subsystems shown in FIG. 6 are interconnected via a system bus 600. Additional subsystems such as a printer 608, keyboard 614, fixed disk 616 (or other memory comprising computer readable media), monitor 620, which is coupled to display adapter 610, and others are shown. Peripherals and input/output (I/O) devices, which couple to I/O controller 602 (which can be a processor or other suitable controller), can be connected to the computer system by any number of means known in the art, such as serial port 612. For example, serial port 612 or external interface 618 can be used to connect the computer apparatus to a wide area network such as the Internet, a mouse input device, or a scanner. The interconnection via system bus allows the central processor 606 to communicate with each subsystem and to control the execution of instructions from system memory 604 or the fixed disk 616, as well as the exchange of information between subsystems. The system memory 604 and/or the fixed disk 616 may embody a computer readable medium.

Embodiments of the technology are not limited to the above-described embodiments. For example, although separate functional blocks are shown for an issuer, payment processing network, and acquirer, some entities perform all of these functions and may be included in embodiments of the technology.

Further, additional embodiments of the invention may be directed to methods and systems involving merchants, and their access devices, as well as issuers. For example, other embodiments may include the following additional embodiments.

One embodiment may be directed toward communications between the mobile communication device and the issuer, wherein the mobile communication device may request a balance inquiry and the issuer may return an account balance in response over the secure channel.

Specific details regarding some of the above-described aspects are provided above. The specific details of the specific aspects may be combined in any suitable manner without departing from the spirit and scope of embodiments of the technology. For example, back end processing, data analysis, data collection, and other transactions may all be combined in some embodiments of the technology. However, other embodiments of the technology may be directed to specific embodiments relating to each individual aspect, or specific combinations of these individual aspects.

It should be understood that the present technology as described above can be implemented in the form of control logic using computer software (stored in a tangible physical medium) in a modular or integrated manner. Based on the disclosure and teachings provided herein, a person of ordinary skill in the art will know and appreciate other ways and/or methods to implement the present technology using hardware and a combination of hardware and software

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the technology will become apparent to those skilled in the art upon review of the disclosure. The scope of the technology should, therefore, be determined not with reference to the above description, but instead should be determined with reference to the pending claims along with their full scope or equivalents.

One or more features from any embodiment may be combined with one or more features of any other embodiment without departing from the scope of the technology.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method of using a mobile communication device comprising a mobile security application, a key associated with the mobile security application, a first mobile payment application in communication with the mobile security application and a second mobile payment application in communication with the mobile security application, the method comprising:
communicating, by the first mobile payment application in the mobile communication device with a mobile gateway, in a first communication, wherein the first communication is encrypted using the key; and
communicating, by the second mobile payment application in the mobile communication device with the mobile gateway, in a second communication, wherein the second communication is encrypted using the key.

2. The method of claim 1 wherein the key is a UDK.

3. The method of claim 1 wherein the key is present in the mobile security application.

4. The method of claim 1 wherein the mobile security application, the first mobile payment application, and the second mobile payment application are stored in a secure element in the mobile communication device.

5. The method of claim 1 wherein the mobile communication device is a mobile phone.

6. The method of claim 1 wherein the mobile communication device further comprises an unsecured application, wherein the first and second communications utilize the unsecured application.

7. The method of claim 6 wherein the unsecured application comprises account data.

8. The method of claim 7 wherein the account data is sent to the mobile gateway via the mobile security application.

9. The method of claim 7 wherein the account data includes an account number associated with a payment card issued by an issuer.

10. The method of claim 1 wherein the first communication and the second communication are selected from a group consisting of issuer application updates, balance updates, updating parameters for the mobile communication device, blocking a respective mobile payment application on the mobile communication device, unblocking the respective mobile payment application, disabling payment functionality on the mobile communication device, unblocking a passcode on the mobile communication device, changing the passcode on the mobile communication device, or setting the passcode to a default passcode.

11. A mobile communication device comprising:
a processor;
a secure element comprising a mobile security application associated with the processor, a key associated with a mobile security application, a first mobile payment application associated with the mobile security application, and a second mobile payment application associated with the mobile security application, wherein the processor is configured to use the key to encrypt a first communication between the first mobile payment application and a mobile gateway, and wherein the processor is further configured to use the key to encrypt a second communication between the second mobile payment application and the mobile gateway; and
an antenna coupled to the processor.

12. The mobile communication device of claim 11 wherein the key is a UDK.

13. The mobile communication device of claim 11 wherein the key is present in the mobile security application.

14. The mobile communication device of claim 11 wherein the mobile security application, the first mobile payment application, and the second mobile payment application are stored in a secure element in the mobile communication device.

15. The mobile communication device of claim 11 wherein the mobile communication device is a mobile phone.

16. The mobile communication device of claim 11 wherein the mobile communication device further comprises an unsecured application, wherein the first and second communications utilize the unsecured application.

17. The mobile communication device of claim 16 wherein the unsecured application comprises account data.

18. The mobile communication device of claim 17 wherein the account data is sent to the mobile gateway via the mobile security application.

19. The mobile communication device of claim 17 wherein the account data includes an account number associated with a payment card issued by an issuer.

20. The mobile communication device of claim 11 wherein the first communication and the second communication are selected from a group consisting of issuer application updates, balance updates, updating parameters for the mobile communication device, blocking a respective mobile payment application on the mobile communication device, unblocking the respective mobile payment application, disabling payment functionality on the mobile communication device, unblocking a passcode on the mobile communication device, changing the passcode on the mobile communication device, or setting the passcode to a default passcode.
